(19) United States
(12) Patent Application Publication
(10) Pub. No.: US 2008/0222942 A1
(43) Pub. Date: Sep. 18, 2008

(54) Method of Detecting and Exterminating Rodents

(76) Inventor: D. Vernon Dalton, Wells, NV (US)

Correspondence Address: THORPE NORTH & WESTERN, LLP., P.O. Box 1219, SANDY, UT, 84091-1219, US

(21) Appl. No.: 12/047,145

(22) Filed: Mar. 12, 2008

Related U.S. Application Data
(60) Provisional application No. 60/906,635, filed on Mar. 12, 2007.

(51) Int. Cl. A01M 23/00; G01V 9/00

(52) U.S. Cl. 43/58; 43/124; 702/2

(57) ABSTRACT

A method of detecting and exterminating rodents can include collecting geographical data of underground rodent tunnels and nests within a defined geographical region. Additionally, the method can include processing the geographical data, and presenting the data in a form sufficient to allow an operator to identify a location of the underground rodent tunnels and nests. A method of detecting and exterminating rodents also can include exterminating rodents dwelling in the underground tunnels and nests. A system of detecting and exterminating rodents includes a substantially above-ground surveyor which can generate data of underground rodent tunnels and nests, and a data processor which can receive, store, interpret and present the data generated by the surveyor. Additionally, the system can also include an exterminating device.

### RELATED APPLICATION

This application claims the benefit of U.S. Provisional Application No. 60/906,635, filed Mar. 12, 2007, which application is incorporated herein by reference.

### BACKGROUND OF THE INVENTION

Rodents, such as gophers, mice, moles, and rats have long been known to threaten food production by causing damage to vegetation, including agricultural crops. Some of the damage results from the feeding activities of rodents. For example, some rodents such as pocket gophers, may feed on above-ground vegetation. They may also feed on subsurface roots. A typical pocket gopher feeds on a variety of vegetation including vegetables, herbs, grains, grasses, shrubs, and small trees. Other agricultural damage caused by rodents includes the result of tunneling and mounding activities. For example, some rodents such as pocket gophers construct mounds of soil and rocks that can result in considerable damage to harvesting machinery. Further, over time tunnels can cause subsidence and uneven surface topography which can be unsightly, inconvenient, and often requires grading or leveling.

Many rodents, such as pocket gophers, dwell in underground tunnels and nests. Because their habitat is underground, it can be difficult to locate and exterminate these pests. Known methods of locating underground rodent tunnels and nests can be cumbersome and include manually inserting a probe into the ground's surface to feel or test various properties for tunnels and nests. Such methods are not feasible particularly for agricultural applications where there is a substantial amount of area to be covered. Thus, the industry continues to seek improved methods and products which will aid in the detection and extermination of undesired rodents.

### SUMMARY OF THE INVENTION

The present invention provides a method of detecting and exterminating rodents. The method includes collecting geographical data of underground rodent tunnels and nests within a defined geographical region, and processing the geographical data. The method also includes presenting the data in a form sufficient to allow an operator to identify a location of the underground rodent tunnels and nests. Finally, the method comprises exterminating rodents that dwell in the underground tunnels and nests. Thus, the method of the present invention can be a viable alternative for existing methods of locating and exterminating rodents.

In accordance with the present invention, collecting geographical data can be accomplished using a variety of instruments and techniques. One method includes collecting data by transmitting and receiving electromagnetic signals using a frequency domain electromagnetic system. Collecting geographical data can also be accomplished by transmitting and receiving electromagnetic signals using ground penetrating radar. One method of the present invention includes collecting geographical data using shallow seismic reflection. In another method, collecting geographical data is accomplished by transmitting and receiving signals using geophones. Still yet another method includes collecting data by measuring the resistance of an electrical current introduced into a specific surface location of the geographical region. Finally, in one method of the present invention, collecting geographical data can be accomplished by taking thermal images of the defined geographical region using a thermographic camera.

The collecting, processing and presenting of data in the present invention can occur simultaneously. In one aspect, actual extermination or implanting of an exterminating mechanism of the rodents occurs within 5 minutes of collecting, interpreting and presenting the data.

Once underground data has been collected and processed, a suitable extermination step can be applied. For example, a rodenticide can be placed in underground tunnels and/or nests based on the information collected and processed.

The present invention also provides a system of detecting and exterminating rodents. The system can include a substantially above-ground surveyor which can generate data of underground rodent tunnels and nests. The system can also include a data processor which can receive, store, interpret and present the data generated by the surveyor. Finally, the system of the present invention also includes an exterminating device. The surveyor of the present invention typically comprises at least one member selected from the group consisting of electromagnetic sensors, radar antennas, geophones, resistance meters, magnetometers, gradiometers, thermographic cameras, and combinations of these devices.

In one aspect, the surveyor of the present invention can further include a mobility attachment which facilitates transport and movement of the surveyor. For example, the surveyor can also include wheels, skids, or the like. The surveyor and data processor can be contained in a single structural unit, and the surveyor can further be optionally structurally connected to the exterminating device on a common platform. In one embodiment of the present invention, the data processor generates a map of the underground rodent tunnels and nests from the data.

With respect to the exterminating device, in one aspect it can be a rodenticide. In another aspect it can be a high voltage electrode, and in still yet another aspect, it can comprise a mechanical rodent trap.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 shows a perspective view of a system of detecting and exterminating rodents wherein the surveyor and data processor are contained in a single structural unit which is structurally connected to the exterminating device on a single platform in accordance with one embodiment of the invention.

FIG. 2 shows a view of a partial system of detecting and exterminating rodents, wherein the surveyor includes a mobility attachment and is attached to a tractor in accordance with another embodiment of the invention.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

It must be noted that, as used in this specification and the appended claims, the singular forms “a,” “an,” and “the” include plural referents unless the context clearly dictates otherwise. Thus, for example, reference to “an exterminating device” includes one or more of such devices, and reference to “a signal” includes reference to one or more of such signals.

Definitions

In describing and claiming the present invention, the following terminology will be used in accordance with the definitions set forth below.

As used herein, “above-ground surveyor” refers to a device that is capable of sending and receiving signals to identify underground geographic features. The position from which an above-ground surveyor sends and receives signals is either wholly or in-part at or above ground surface level. An “above-ground surveyor” can refer to a single component or unit. Alternatively, “above-ground surveyor” can refer to a combination of units or components.

As used herein, “sub-surface” refers to a location that is beneath the surface of the earth or beneath ground surface level, i.e. below grade, whether natural or man-made grade.

As used herein, “seismic source” refers to any device or combination of devices that are capable of providing an energy pulse to generate seismic waves in the ground.

As used herein, “substantial” when used in reference to a quantity or amount of a material, or a specific characteristic thereof, refers to an amount that is sufficient to provide an effect that the material or characteristic was intended to provide. Therefore, “substantially free” when used in reference to a quantity or amount of a material, or a specific characteristic thereof, refers to the absence of the material or characteristic, or to the presence of the material or characteristic in an amount that is insufficient to impart a measurable effect, normally imparted by such material or characteristic.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 10 MHz to 1000 MHz” should be interpreted to include not only the explicitly recited values of about 10 MHz and about 1000 MHz, but also include individual values and sub-ranges within the indicated range. Thus, included in this numerical range are individual values such as 20, 30, and 40 and sub-ranges such as from 10-30, from 20-40, and from 30-50, etc. This same principle applies to ranges reciting only one numerical value. Furthermore, such an interpretation should apply regardless of the breadth of the range or the characteristics being described.

The Invention

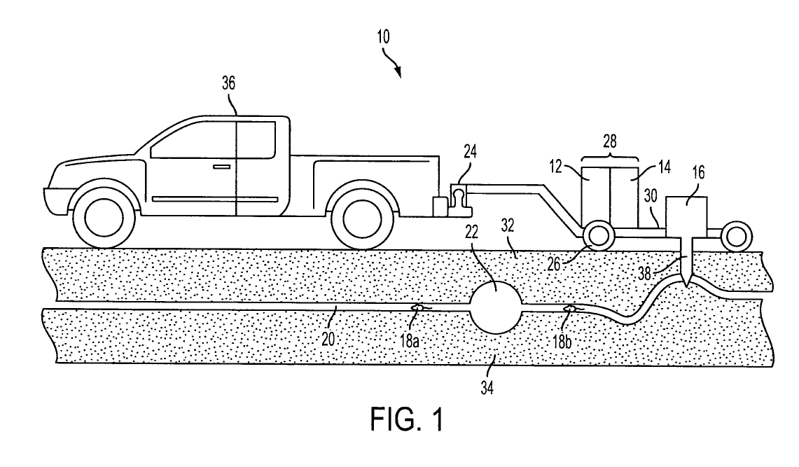

The present invention teaches both a method and associated system of detecting and exterminating rodents. In accordance with an embodiment of the present invention as shown in FIG. 1, rodents 18a, 18b can be detected and exterminated by collecting geographical data of underground rodent tunnels 20 and nests 22 within a defined geographical region. The data can be processed and presented in a form sufficient to allow an operator to identify a location of the underground rodent tunnels and nests. Upon identification of the underground rodent tunnels and nests, rodents dwelling therein can be exterminated.

In accordance with the system 10 of the present invention, also shown in FIG. 1, an above-ground surveyor 12 is provided which can generate data of underground rodent tunnels 20 and nests 22. The system can further include a data processor 14 which can receive, store, interpret and present the data generated by the surveyor. The system can also comprise an exterminating device 16. In accordance with the embodiments of the method and system, various details are provided herein which are applicable to each of the method and the associated system of detecting and exterminating rodents.

Referring to FIG. 1, a method is provided whereby rodents 18a and 18b can be detected and exterminated. The method includes collecting geographical data of underground rodent tunnels 20 and nests 22 within a defined geographical area. The defined geographical area can be any size. For example, the method of the present invention may be suitable for large areas, including farmland and agricultural areas comprising one or more acres. Alternatively, the method of the present invention can be applied to smaller areas of less than one acre, and more particularly specific areas where there may be evidence of recent rodent activity.

The defined geographical area may include a specified depth from which data can be collected. It is desirable to survey and collect geographical data from a depth at least as deep as the suspected rodent tunnels and nests. The depth of typical rodent tunnels may vary with soil type, however depths are relatively shallow and rarely exceed about 6 feet deep. For example, in sandy soils, the average pocket gopher tunnel can range from about 7 inches to 27 inches deep, and nests may be up to 5 feet or 6 feet deep. In heavier soils, such as those with high clay content, tunnels may be shallower; ranging from about 6 inches to about 19 inches deep. Accordingly, the method and system of the present invention may be used to detect gopher tunnels and nests ranging from about 5 inches to about 30 inches deep.

Collecting geographical data of underground rodent tunnels and nests can be accomplished in a number of different manners using a variety of different types of equipment. In accordance with the present invention, the methods and devices used in connection with collecting geographical data typically do not require substantial physical disruption of the ground surface, but rather can be accomplished with minimal or no physical subsurface contact. In one aspect, collecting geographical data is accomplished by transmitting electromagnetic signals into the ground 32 and receiving electromagnetic signals using a frequency domain electromagnetic system (FDEM). In one embodiment the FDEM comprises broadband digital electromagnetic sensors, which facilitate electromagnetic induction spectroscopy (EMIS). When using EMIS, a user can distinguish objects based on a variety of object properties including but not limited to electrical conductivity, geometry and material composition. In one embodiment of the present invention, multiple frequencies can be used. This can be beneficial in order to adjust signals for varying types of soils and conditions, e.g. rock content, permeability, etc.

In another aspect of the present invention, collecting geographical data is accomplished by transmitting and receiving electromagnetic signals using ground penetrating radar (GPR). GPR can be particularly effective in surveying and providing clear resolution of the relatively shallow tunnels and nests of subterranean rodents. GPR used in accordance with the present invention can use antennas to transmit an electromagnetic pulse or radar pulse into the ground 32. The antennae can also receive and measure the return signal from subsurface features. In one aspect, the antennas transmit signals ranging from about 10 to about 1600 MHz. Frequency can be varied in order to optimize mapping and signal strength based on varying ground type and conditions. The antenna or antennas can be positioned so that they are in contact with the ground. Alternatively, the antenna or antennas can be positioned so that they are not in physical contact with the ground. In one aspect, a transmitting antenna and a receiving antenna can both be comprised in a single surveyor or unit. In another aspect, a transmitting antenna and a receiving antenna can be comprised in separate units.

Collecting geographical data in accordance with the present invention can also be accomplished by using shallow seismic reflection (SSR) methods. In one aspect, the SSR of the present invention can include placing geophones in a defined geographical area that is to be searched for underground rodent tunnels 20 and nests 22. In one embodiment, a plurality of geophones can be placed throughout the defined geographical area. The method further comprises transmitting seismic vibrations into the ground. In one aspect, this can be accomplished by detonating an explosive device placed in the ground at a known location. The known location can be remote, but sufficiently close to create vibrations which produce a measurable signal. In another aspect this can be accomplished by adopting non-explosive methods, which are known in the art, such as but not limited to, secondary geophones, plate and hammer, and the like. Non-explosive methods can avoid the use of expensive and dangerous explosive materials and are most often reproducible with high repeatability.

In still yet another aspect, collecting geographic data of underground rodent tunnels 20 and nests 22 can be accomplished by measuring the resistance of an electrical current introduced into a specific surface location of the geographical region. Components for measuring resistance can include resistance meters having a multiplexer and probe array.

Geographical data of underground rodent tunnels 20 and nests 22 can also be collected by taking thermal images of the defined geographical region with a thermographic or infrared camera. Thermographic cameras can detect radiation and produce images thereof. Since radiation emitted from an object increases with the temperature of the object, a user may be able to distinguish one subsurface feature from another subsurface feature assuming that the respective subsurface features have different temperatures. For example, an underground rodent nest 22 tends to be substantially warmer than the surrounding soil 34, and will thus emit more radiation than the surrounding soil. In such cases, thermographic cameras will collect and record the location wherein increased radiation is being emitted, thereby enabling the user to locate an underground rodent tunnel or nest. This approach can be especially effective for shallow nests and tunnels or in cooler climate conditions where thermal gradients are more pronounced and have less distance to allow for diffusion of heat into surrounding earth.

The method of detecting and exterminating rodents 18a, 18b can further comprise processing the geographical data and presenting the data in a form sufficient to allow an operator to identify a location of the underground rodent tunnels 20 and nests 22. In one aspect, data can be processed and presented at the location wherein the data is collected. For example, a single unit 28 can be configured to collect raw geographical data, process, and present the data. In another aspect, the geographical data can be collected within a defined geographical region and can be transported either physically or electronically (e.g. direct connection, wireless, rf, or the like) to another location where it is processed and presented in a form that is sufficient to enable a user to locate underground rodent tunnels 20 and nests 22 within the defined geographical region. A variety of data processing and data presentation equipment can be used in accordance with the present invention. The data processing and data presentation equipment selected will likely depend upon the method employed for collecting the geographical data. For example, where GPR is selected as the manner in which to collect data, the resulting data may be processed by a data processor configured to process electromagnetic signals. Such data processing can include producing useful graphical images via imaging software which present 2-D or 3-D maps of underground features. Suitable software can include, but is not limited to, GPR-SLICE (available from Geophysical Archaeometry Laboratory), RADAN (available from Geophysical Survey System, Inc.), GRADIX (available from Interpex), GRORADAR, SPW GPR (available from Parallel Geoscience), and the like.

In a further aspect of the present invention, collecting, processing and presenting the data all occur substantially simultaneously. Alternatively, collecting, processing and presenting the data may occur at different times. For example, in one aspect, data of underground rodent tunnels 20 and nests 22 can be collected using any of the collection methods described herein. In this aspect, once the data is collected it can be stored on a data storage device such as an electronic storage device. Electronic data pertaining to underground rodent tunnels and nests can be stored in an analog signal format. Alternatively, electronic data of the present invention can be stored in digital signal format. Non-limiting examples of storage devices that can be used in accordance with the present invention to hold geographical data include memory cards, magnetic tape, USB keydrives, CD-R, CD-RW, CD-ROM, etc. Once the raw data is stored on a storage device, the data on the storage device can either be processed and presented on-site or transported to another location.

Subsequent to the production and identification of underground features such as tunnels and nests, the information can be used to determine optimal placement and/or use of rodent removal or extermination efforts. Although extermination can often be the goal, non-lethal approaches may also be applied such as capture and release. In one aspect, the method of detecting and exterminating rodents of the present invention further comprises exterminating rodents 18a, 18b dwelling in the underground tunnels 20 and nests 22. Any known method of exterminating rodents can be employed in the present invention. Likewise, any known exterminating device can be utilized in the present invention. In one aspect, exterminating the rodents is accomplished by placing a rodenticide in the underground tunnels and nests. For example, the rodenticide can be in the form of a gas that is placed in the underground rodent tunnels and nests once they are located. The gas can contain a toxin that is fatal to a rodent upon contact therewith. In another embodiment, the gas can be such that it results in suffocation of any rodent dwelling in the underground tunnels or nests. In one aspect, the rodenticide can be in the form of poison-containing bait that will attract rodents. Upon ingesting the bait, the rodent will die. Non-limiting examples of suitable poisons can include strychnine (optionally on grain bait), anticoagulants chlorophacinone and diphacinone, and the like.

In another aspect, rodents 18a, 18b dwelling in underground tunnels 20 and nests 22 can be exterminated by electrocution. For example, probes comprising high voltage electrodes can be inserted into the tunnels and nests. Upon contact between a rodent and a probe, the rodent will be electrocuted and thus exterminated. In another embodiment, rodents can be exterminated via use of traditional rodent traps placed in one or more locations throughout the underground rodent tunnels. In this embodiment, bait is placed on or near the trap. When the rodent approaches the trap, the trap can be activated resulting in death of the rodent via mechanical force. In another aspect, the trap can be used without bait. Non-limiting examples of suitable traps can include spear traps, pinch traps, box trap, wire trap, and the like. Other extermination methods can include concussion blasts where a combustable fuel is ignited to send a flame and shock wave throughout the tunnel system.

One advantage of the present invention is the speed at which such rodent can be located, reducing the likelihood of the extermination device missing. In some embodiments, extermination can occur within 5 to 10 minutes of mapping the underground formations. In one aspect of the present invention, exterminating the rodent 18a, 18b occurs within 5 minutes of collecting, processing and presenting the geographical data of underground rodent tunnels 20 and nests 22. In another aspect, exterminating the rodent occurs more than 5 minutes after collecting, processing and presenting the data. Typically, exterminating the rodent is best accomplished when the collected data is current. For example, if a substantial amount of time passes between collecting the data of underground rodent tunnels and nests and exterminating rodents dwelling therein, there is a possibility that the detected tunnels could be abandoned. Therefore, it may be futile to place an exterminating device in the abandoned tunnel or nest. Accordingly, the rate of success of the method of the present invention typically decreases as the time between collecting data and extermination efforts increases. Furthermore, the present invention can allow for effective identification of abandoned tunnels versus active tunnels. For example, imaging data can readily show areas which evidence non-use such as collapsed or blocked sections.

Referring to FIG. 1, the present invention provides a system 10 of detecting and exterminating rodents. The system comprises a substantially above-ground surveyor 12 which can generate data of underground rodent tunnels 20 and nests 22. In one aspect of the present invention, the surveyor comprises at least one member selected from the group consisting of electromagnetic sensors, radar antennae, geophones, resistance meters, magnetometers, gradiometers, and thermographic cameras, as discussed previously. Selection of a member or members from the group identified can depend on the size of the area searched, temperature, soil content, soil grain size, and soil compaction of the ground wherein rodent tunnels and nests are suspected.

In detecting underground rodent tunnels 20 and nests 22, electromagnetic sensors can be used with frequency domain electromagnetic systems or ground penetrating radar systems. Likewise, antennas can be used in connection with ground penetrating radar systems. In one aspect, geophones can be used in combination with a seismic source for detecting underground rodent tunnels and nests. The seismic source can be any known seismic source. In one embodiment, the seismic source can be dynamite or other known explosive or combinations thereof. In another embodiment, the seismic source can be a non-explosive source such as a specialized air gun, secondary geophone, hammer-plate, or other device which can provide a pulse of energy to generate seismic waves in the ground.

In one aspect, resistance meters can be integrated into the surveyor 12. Resistance meters can be used to perform an electrical resistivity survey of the defined geographic region. In one aspect, multiplexers and probe arrays or combinations thereof can be used in connection with resistance meters for performing an electrical resistivity survey. In another aspect, the surveyor of the present system can include magnetometers to perform magnetic field gradient surveys for detecting underground rodent tunnels and nests. Gradiometers can also be used in connection with magnetic field gradient surveys. In a further aspect, gradiometers comprising two magnetic sensors can be integrated into the present system for detecting underground rodent tunnels 20 and nests 22.

In a further aspect of the present invention, the surveyor 12 can comprise a thermographic camera. The thermographic camera can be configured to generate data of underground rodent tunnels 20 and nests 22. Additionally, the thermographic camera may be able to identify the exact location of a rodent 18a, 18b at a specific time. In a similar aspect, heat sensing, infrared technology may be used for detecting underground rodents. According to one example, the surveyor can comprise a heat sensing, infrared detector. Upon detection of an underground rodent, the exterminating device can be activated.

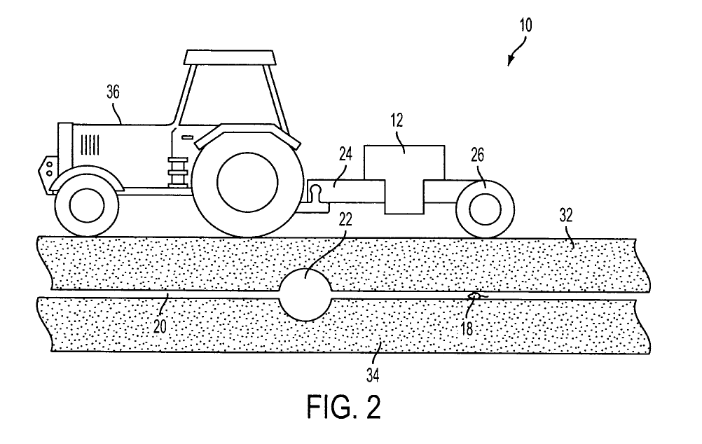

With respect to the physical structure of the system 10 of the present invention as shown in FIGS. 1 and 2, the surveyor 12 can further include a mobility attachment 24. The mobility attachment can take on any known configuration for making an object mobile. For example, in one aspect the mobility attachment can be a wheel 26 or wheels attached directly to the surveyor. In another aspect, the surveyor can be carried by a trailer or platform 30 that is connected to a vehicle 36 such as a tractor, truck, or all terrain vehicle. In another aspect, the surveyor can be carried by a push cart (not shown) that can be either manually or remotely operated. Additionally, either an electric or mechanical odometer, such as a wheel odometer, can be coupled to the surveyor. An odometer can be useful for measuring distances, thus furthering efforts to accurately identifying the location of detected tunnels 20 and nests 22. In still yet another aspect, the mobility attachment can be a handlebar (not shown) configured to enable a human operator to hold the surveyor while collecting geographical data.

In one embodiment, the surveyor 12 can be in contact with the ground 32 when collecting geographical data. In another aspect the surveyor is not in contact with the ground when collecting data. In still yet another aspect, some components of the surveyor can be in contact with the ground while other components are not. Regardless, the surveyors used in the present invention are non-intrusive and do not require penetration of ground surfaces. This can be highly advantageous in terms of operation time, disruption and ease of operation.

With respect to the embodiment of the present system 10 as shown in FIG. 1, the surveyor 12 and the data processor 14 can be contained in a single structural unit 28. In another embodiment, as shown in FIG. 2, the surveyor and data processor can be included in different units. While the surveyor is positioned in the vicinity of the defined geographical region from which data is being collected, the data processor may or may not be located in the same vicinity as the surveyor.

The data processor 14 of the present invention can present data in any known form of data presentation. According to one aspect of the present invention, the data processor can present data generated by the surveyor in the form of a map showing underground rodent tunnels 20 and nests 22. In a further aspect, the map can resemble that of a two-dimensional typical road map. In another aspect, the map can show three-dimensional features such as the depth of the tunnels and nests. In one aspect, the data processor can present data in the form of a graph or Cartesian coordinates and vectors that coincide with the location of underground rodent tunnels and nests.

With respect to the exterminating device 16, in one aspect of the present invention the exterminating device can be structurally connected to the surveyor on a common platform 30. The platform can be a trailer similar to that shown in FIG. 1. In practice, this embodiment can facilitate extermination of the rodent within a few minutes of detecting underground rodent tunnels 20 and nests 22. For example, a vehicle 36 could pull a trailer carrying the surveyor 12, data processor 14 and exterminating device 16. In this aspect, the surveyor can collect data regarding the geographic area or ground 32 substantially directly below the surveyor. Additionally, in one aspect, the data processor can receive, store, interpret and present the data collected by the surveyor substantially instantaneously. In this aspect, the exterminating device can exterminate rodents 18a, 18b dwelling in any tunnels or nests detected by the surveyor. For example, as an exterminating device 16 is pulled over a detected tunnel or nest, it can insert a poison or bait into the ground to a depth sufficient to place the bait or poison in detected tunnels and nests. Exterminating devices that can be useful in this type of application include devices comprising a probe 38 or an array of probes configured to be inserted into the ground and further configured to release poison or bait into detected rodent tunnels and nests. In a preferred aspect, the probe can be automated so that it is activated when underground tunnels or nests are detected. In another aspect, the probe or other exterminating device can be manually placed or inserted into the tunnel or nest by a human operator.

The exterminating device 16 can further comprise a fluid delivery system. Delivered fluid can be in the form of a liquid or gas. In one aspect the fluid delivery system can be configured to force water into detected tunnels 20 and nests 22, thus drowning rodents 18a, 18b dwelling therein. The water can be delivered via a standard hose that is connected to a water source on one end and to a tunnel or nest opening on the other end. In one aspect, a pressurized tank containing water can be carried on or by a vehicle to a location where tunnels and nests have been detected. A delivery line can be coupled to the pressurized tank on one end and inserted into underground tunnels and nests. Water can be forced from the tank and into the tunnel or nest to drown rodents dwelling therein. The force of the water can be sufficient to exterminate rodents if the delivery line is positioned directly into a nest. In one aspect, a poison can be mixed with the water prior to forcing the water into the tunnel. This could effectively exterminate any rodents that do not drown in the water.

In another embodiment, the fluid delivered into the tunnel or nest can be a gas, such as carbon monoxide (“CO”). Carbon Monoxide is a colorless, odorless and tasteless toxic gas, which can be used to successfully exterminate rodents. By way of example and not by way of limitation, the fluid delivery system can be coupled to the exhaust system of an internal combustion engine, such as the engine of a vehicle transporting the detection and extermination system or other engine configured specifically for the intended application, e.g. to avoid excess back-pressure in the exhaust system. In this way, exhaust containing carbon monoxide can travel from the exhaust system and into the detected tunnels and nests. The rodent can ultimately suffocate as a result of inhalation of the carbon monoxide.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiment(s) of the invention. It will be apparent to those of ordinary skill in the art that numerous modifications can be made without departing from the principles and concepts of the invention as set forth in the claims.

What is claimed is:

1. A method of detecting and exterminating rodents, comprising:
a) collecting geographical data of underground rodent tunnels and nests within a defined geographical region;
b) processing the geographical data;
c) presenting the data in a form sufficient to allow an operator to identify a location of the underground rodent tunnels and nests; and
d) exterminating rodents dwelling in the underground tunnels and nests.

2. A method as in claim 1, wherein the rodent tunnels are positioned from about 5 inches to about 30 inches beneath the surface of the earth.

3. A method as in claim 1, wherein the nests are positioned from about less than 1 foot to about 6 feet beneath the earth's surface.

4. A method as in claim 1, wherein collecting geographical data is accomplished by transmitting and receiving electromagnetic signals using a frequency domain electromagnetic system.

5. A method as in claim 1, wherein collecting geographical data is accomplished by transmitting and receiving electromagnetic signals using ground penetrating radar.

6. A method as in claim 1, wherein collecting geographical data is accomplished by using shallow seismic reflection.

7. A method as in claim 6, wherein shallow seismic reflection is accomplished by transmitting and receiving signals using a seismic source and geophones.

8. A method as in claim 1, wherein collecting geographical data is accomplished by measuring the resistance of an electrical current introduced into a specific surface location of the geographical region.

9. A method as in claim 1, wherein collecting geographical data is accomplished by taking thermal images of the defined geographical region using a thermographic camera.

10. A method as in claim 1, wherein exterminating the rodents is accomplished by placing a rodenticide in the underground rodent tunnels and nests.

11. A method as in claim 1, wherein collecting, processing and presenting the data all occur substantially simultaneously.

12. A method as in claim 1, wherein exterminating the rodents occurs within 5 minutes of collecting, processing, and presenting the data.

13. A system of detecting and exterminating rodents, comprising:
a) a substantially above-ground surveyor which can generate data of underground rodent tunnels and nests;
b) a data processor which can receive, store, interpret and present the data generated by the surveyor; and
c) an exterminating device.

14. A system as in claim 13, wherein the surveyor comprises at least one member selected from the group consisting of electromagnetic sensors, radar antennas, geophones, resistance meters, magnetometers, gradiometers, and thermographic cameras.

15. A system as in claim 13, wherein the surveyor further includes a mobility attachment.

16. A system as in claim 13, wherein the surveyor comprises wheels.

17. A system as in claim 13, wherein the surveyor and data processor are contained in a single structural unit.

18. A system as in claim 13, wherein the exterminating device is structurally connected to the surveyor on a common platform.

19. A system as in claim 13, wherein the data processor generates a map of the underground rodent tunnels and nests from the data.

20. A system as in claim 13, wherein the exterminating device is a rodenticide source.

21. A system as in claim 13, wherein the exterminating device is a high voltage electrode.

22. A system as in claim 13, wherein the exterminating device comprises a mechanical rodent trap.
